(19) United States
(12) Patent Application Publication
(10) Pub. No.: US 2015/0230064 A1
(43) Pub. Date: Aug. 13, 2015

(54) METHOD AND APPARATUS FOR ALLOCATING BROADCASTING CHANNEL

(71) Applicant: Electronics and Telecommunications Research Institute, Daejeon (KR)

(72) Inventors: Dae Soon CHO, Daejeon (KR); IL GYU KIM, Chungcheongbuk (KR); Seung Chan BANG, Daejeon (KR)

(21) Appl. No.: 14/617,643

(22) Filed: Feb. 9, 2015

(30) Foreign Application Priority Data
Feb. 13, 2014 (KR) 10-2014-0016907

(51) Int. Cl. H04W 4/06; H04W 72/04

(52) U.S. Cl. CPC H04W 4/06; H04W 72/0446

(57) ABSTRACT

An apparatus for allocating a broadcasting channel in each cell determines a position to which the broadcasting channel is to be allocated using a number of cell IDs and a cell ID of each cell which is allocated different from neighboring cells in a subframe of a downlink frame, and allocates the broadcasting channel to the determined position.

### CROSS-REFERENCE TO RELATED APPLICATION

This application claims priority to and the benefit of Korean Patent Application No. 10-2014-0016907 filed in the Korean Intellectual Property Office on Feb. 13, 2014, the entire contents of which are incorporated herein by reference.

### BACKGROUND OF THE INVENTION

(a) Field of the Invention

The present invention relates to a method and an apparatus for allocating a broadcasting channel, and more particularly, to a method and an apparatus for allocating a broadcasting channel taking account of inter-cell interference.

(b) Description of the Related Art

In an existing mobile communication system, a broadcasting channel is allocated to the same resource of a physical channel frame without taking account of inter-cell interference, so interference occurs in neighboring cells broadcasting in the channel area.

As described above, once the broadcasting channel of each cell is allocated to the same resource, the inter-cell interference occurs, which deteriorates decoding performance of the broadcasting channel and causes more serious performance deterioration at a cell boundary region. Particularly, in a mobile hotspot network (MHN) that supports a group moving speed of 400 km/h or more, the decoding performance of the broadcasting channel is particularly important. Therefore, there is a need for a method for efficiently allocating a channel that improves reception performance and decoding performance of the broadcasting channel.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for allocating a broadcasting channel having advantages of efficiently allocating an inter-cell broadcasting channel.

An exemplary embodiment of the present invention provides a method for allocating a broadcasting channel in a cell. The method for allocating a broadcasting channel in a cell includes determining a position to which the broadcasting channel is to be allocated, using a number of cell IDs and a cell ID of the cell which is allocated to be different from neighboring cells in a subframe of a downlink frame, and allocating the broadcasting channel to the determined position.

The number of cell IDs may be determined according to a number of slots in the subframe.

The determining of the position may include calculating a slot position to which the broadcasting channel is to be allocated, based on a remaining value obtained by performing a modular-N arithmetic function for a value of the cell ID, and N may be the number of cell IDs.

The determining of the position may include calculating a symbol position to which the broadcasting channel is to be allocated in a slot, based on the remaining value obtained by performing a modular-N arithmetic function for a value of the cell ID, and N may be the number of cell IDs.

The determining of the position may include calculating a slot position and a symbol position to which the broadcasting channel is to be allocated, based on the remaining value obtained by performing a modular-N arithmetic function for a value of the cell ID, and N may be the number of cell IDs.

The method may further include determining transmission power of the broadcasting channel according to the number of symbols to which the broadcasting channel is allocated.

Another embodiment of the present invention provides a method for allocating a broadcasting channel in a cell. The method for allocating a broadcasting channel in a cell includes: allocating the broadcasting channel to a position which is different from neighboring cells using a number of cell IDs and a cell ID of the cell which is allocated to be different from the neighboring cells in a subframe of a downlink frame; and determining transmission power of the broadcasting channel according to the number of symbols to which the broadcasting channel is allocated.

The allocating of the broadcasting channel may include determining a slot position based on a remaining value obtained by performing a modular-N arithmetic function for a value of the cell ID, and N may be the number of cell IDs.

The allocating of the broadcasting channel may include determining a symbol section in the same slot position based on a remaining value obtained by performing a modular-N arithmetic function for a value of the cell ID, and N may be the number of cell IDs. The allocating of the broadcasting channel may include determining a slot position and a symbol section based on a remaining value obtained by performing a modular-N arithmetic function for a value of the cell ID, and N may be the number of cell IDs.

Yet another embodiment of the present invention provides an apparatus for allocating a broadcasting channel in a cell. The apparatus for allocating a broadcasting channel in a cell includes an allocator, a power determinator, and a transmitter. The allocator may allocate the broadcasting channel to a position which is different from neighboring cells in a subframe of a downlink frame. The power determinator may determine transmission power of the broadcasting channel according to the number of symbols to which the broadcasting channel is allocated. The transmitter may transmit the broadcasting channel with the determined transmission power at the allocated position.

The allocator may determine a position to which the broadcasting channel is to be allocated, using a number of cell IDs and a cell ID of the cell which is allocated to be different from the neighboring cells.

The allocator may determine at least one of a slot position and a symbol section in the same slot based on a remaining value obtained by performing a modular-N arithmetic function for a value of the cell ID, and N may be the number of cell IDs.

The number of cell IDs may be the number of slots in the subframe.

The allocator may allocate the broadcasting channel to a slot position which is different from the neighboring cell in the subframe, allocate the broadcasting channel to a symbol section which is different from the neighboring cells in the same slot, or allocate the broadcasting channel to the slot position which is different from the neighboring cells in the subframe and the symbol section which is different from the neighboring cells in the same slot.

### BRIEF DESCRIPTION OF THE DRAWINGS

FIG. 1 is a drawing showing an example of a downlink frame structure of an MHN system according to an exemplary embodiment of the present invention.

FIG. 2 is a drawing showing an example of one downlink subframe shown in FIG. 1.

FIG. 3 is a drawing showing a first slot of a first subframe of a downlink frame according to an exemplary embodiment of the present invention.

FIGS. 4 to 8 are drawings each showing methods for allocating PBCH according to first to fifth exemplary embodiments of the present invention.

FIG. 9 is a drawing showing an apparatus for allocating a broadcasting channel according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” will be understood to imply the inclusion of stated elements but not the exclusion of any other elements.

Hereinafter, a method and an apparatus for allocating a broadcasting channel according to exemplary embodiments of the present invention will be described in detail with reference to the accompanying drawings.

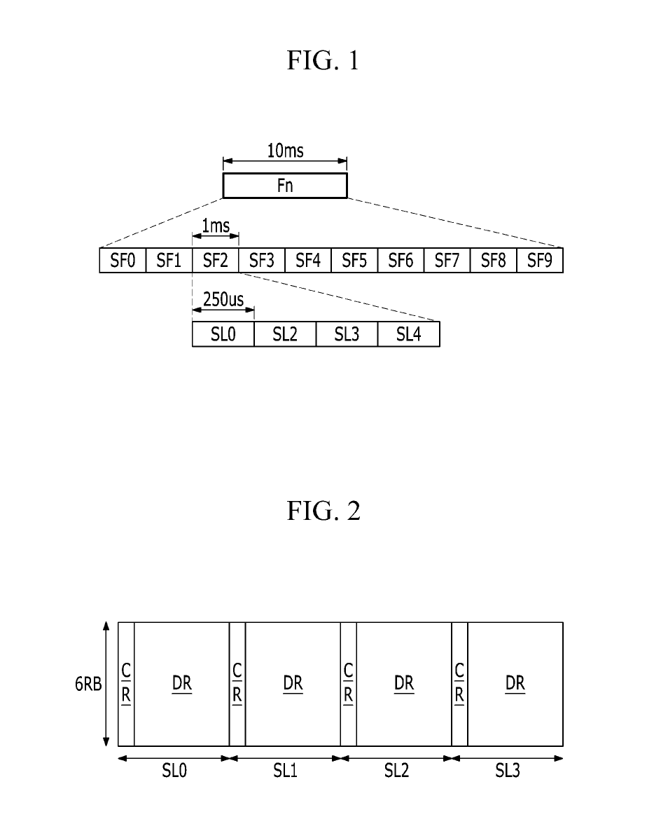

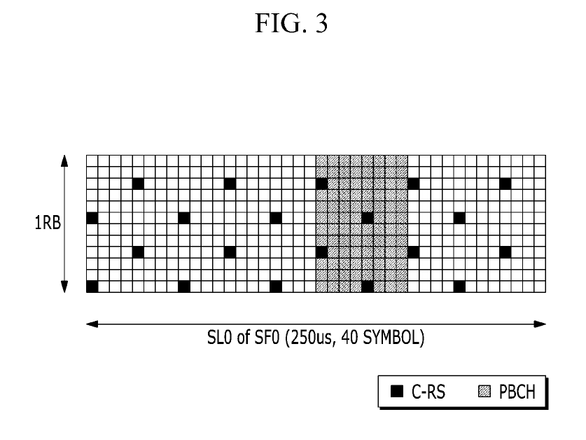

FIG. 1 is a drawing showing an example of a downlink frame structure of an MHN system according to an exemplary embodiment of the present invention, and FIG. 2 is a drawing showing an example of one downlink subframe shown in FIG. 1.

Referring to FIG. 1, a downlink frame Fn in the MHN system has a frame length of 10 ms and includes 10 subframes SF0 to SF9.

Each of the subframes SF0 to SF9 has a length of 1 ms and includes 4 slots SL0 to SL3 each having a length of 250 μs. Each of the slots SL0 to SL3 is configured by 40 OFDM symbols. A time for transmitting each of the slots SL0 to SL3 may be defined as a transmission time interval (TTI).

Referring to FIG. 2, each subframe of the downlink frame includes 4 slots on a time axis and 6 resource blocks (RBs) on a frequency axis.

Each subframe is classified into a control region (CR) and a data region (DR) on the time axis.

Up to three (or four) OFDM symbols which are positioned at a head in each of the slots SL0 to SL3 of the subframe correspond to the control region (CR) to which a control channel is allocated. An example of the downlink control channel includes a physical control format indicator channel (PCFICH), a physical hybrid-ARQ indicator channel (PHICH), a physical downlink control channel (PDCCH), or the like. The PCFICH is a channel that is transmitted in a first OFDM symbol of the subframe, and gives information on the number of OFDM symbols used for transmitting the control channel in the subframe. The PHICH is a channel for a hybrid automatic repeat request (HARQ) acknowledgment/negative-acknowledgment (ACK/NACK) signal transmission as a response for the uplink transmission. In addition, the PDCCH is a channel that gives a physical downlink shared channel (PDSCH) resource allocation, a physical uplink shared channel (PUSCH) resource allocation, power control information, or the like.

The remaining OFDM symbols that are not the OFDM symbols used as the control region in the subframe correspond to the data region (DR) to which the PDSCH is allocated.

In this case, a physical broadcasting channel (PBCH) is allocated across 6 RBs in the first slot SL0 of the first subframe SF0 of the downlink frame. The PBCH, which is a physical channel transmitting master information block (MIB) information, includes downlink channel bandwidth, physical HARQ indication channel configuration information, information of system frame number (SFN), or the like.

FIG. 3 is a drawing showing the first slot of the first subframe of the downlink frame according to an exemplary embodiment of the present invention.

Referring to FIG. 3, the PBCH is allocated to each first slot SL0 of the first subframe SF0 in each downlink frame, and is allocated to 8 OFDM symbol sections from a 20th OFDM symbol to a 27th OFDM symbol, which are an intermediate portion even in the SL0 including 40 OFDM symbols. In addition, the same PBCH is transmitted for 4 successive downlink frames.

However, since the PBCH is allocated to the same resource of the downlink frame for each cell, interference occurs in an inter-cell broadcasting channel region. An allocation method capable of reducing interference between the PBCHs of inter-neighboring cell will be described below.

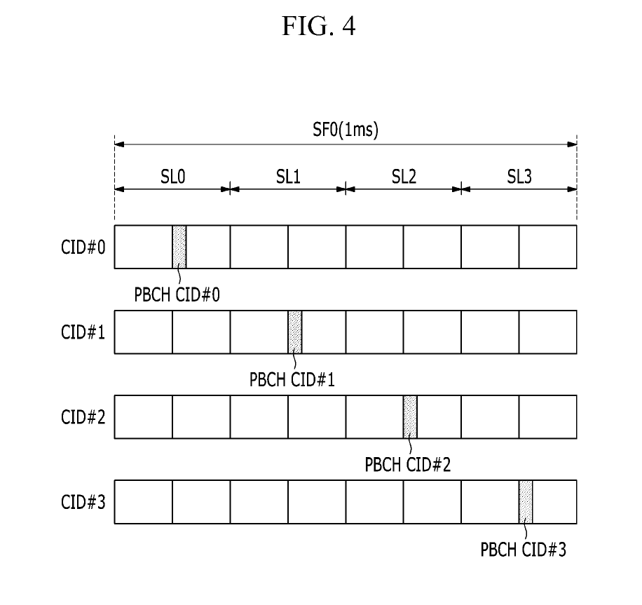

FIG. 4 is a drawing showing a method for allocating PBCH according to a first exemplary embodiment of the present invention.

Referring to FIG. 4, the PBCH of each cell is allocated to PBCHs of the neighboring cells and other slot positions using a cell ID (CID) value and a number of cell IDs. The number of cell IDs may be set to 4, which is the number of slots in one subframe.

In this case, each cell is classified by cell IDs (CID#0, CID#1, CID#2, and CID#3) and the cell IDs (CID#0, CID#1, CID#2, and CID#3) of each cell are allocated to be different from cell IDs of a neighboring cell.

For example, in the case in which cells in the MHN system are classified by the four cell IDs (CID#0, CID#1, CID#2, and CID#3), a slot position to which the PBCH is allocated for each cell may be determined according to the remaining value obtained by performing a modular-4 arithmetic function for the values of the cell IDs (CID#0, CID#1, CID#2, and CID#3).

That is, in the cell of (CID mod 4)=0, the PBCH is allocated to the first slot SL0, in the cell of (CID mod 4)=1, the PBCH is allocated to the second slot SL1, in the cell of (CID mod 4)=2, the PBCH is allocated to the third slot SL2, and in the cell of (CID mod 4)=3, the PBCH is allocated to the fourth slot SL3.

FIG. 4 shows a case in which the PBCH is allocated to the first slot SL0 in the cell having the cell ID of CID#0, the PBCH is allocated to the second slot SL1 in the cell having the cell ID of CID#1, the PBCH is allocated to the third slot SL2 in the cell having the cell ID of CID#2, and the PBCH is allocated to the fourth slot SL3 in the cell having the cell ID of CID#3. That is, FIG. 4 shows a case in which (CID#0 mod 4)=0, (CID#1 mod 4)=1, (CID#2 mod 4)=2, and (CID#3 mod 4)=3.

By the configuration as described above, since an inter-neighboring cell PBCH is allocated to different slot positions, the interference of the inter-neighboring cell PBCH may be alleviated.

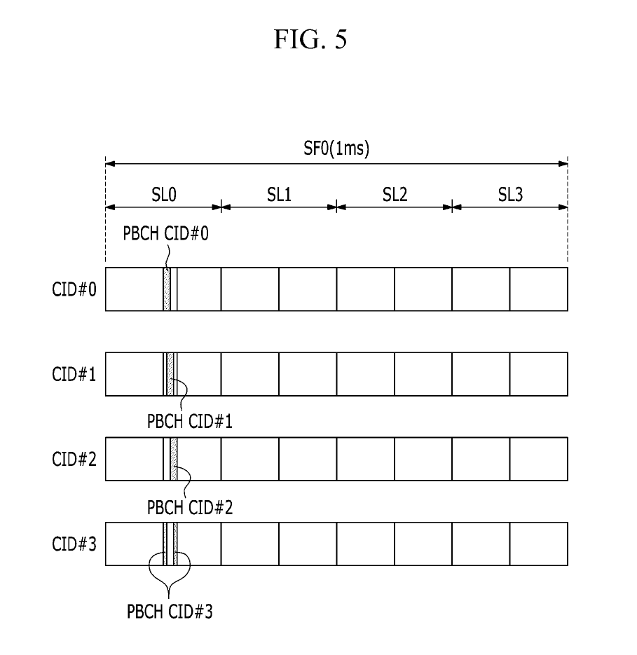

FIG. 5 is a drawing showing a method for allocating PBCH according to a second exemplary embodiment of the present invention.

Referring to FIG. 5, the PBCH of each cell is allocated to positions which are different from PBCHs of the neighboring cells in the same slot using a cell ID value and a number of cell IDs.

For example, in the case in which cells in the MHN system are classified by the four cell IDs (CID#0, CID#1, CID#2, and CID#3), a position to which the PBCH is allocated in the same slot for each cell may be determined according to the remaining value obtained by performing a modular-4 arithmetic function for the values of the cell IDs (CID#0, CID#1, CID#2, and CID#3).

That is, in the cell of (Cell ID mod 4)=0, the PBCH may be allocated to a section from a 20th OFDM symbol to a 23th OFDM symbol in the first slot SL0, in the cell of (Cell ID mod 4)=1, the PBCH may be allocated to a section from a 22th OFDM symbol to a 25th OFDM symbol in the first slot SL0, in the cell of (Cell ID mod 4)=2, the PBCH may be allocated to a section from a 24th OFDM symbol to a 27th OFDM symbol in the first slot SL0, and in the cell of (Cell ID mod 4)=3, the PBCH may be allocated to a section from a 20th OFDM symbol to a 21th OFDM symbol and a section from a 26th OFDM symbol to a 27th OFDM symbol in the first slot SL0.

FIG. 5 shows a case in which the PBCH is allocated to the section from the 20th OFDM symbol to the 23th OFDM symbol in the first slot SL0 in the cell having the cell ID of CID#0, the PBCH is allocated to the section from the 22th OFDM symbol to the 25th OFDM symbol in the first slot SL0 in the cell having the cell ID of CID#1, the PBCH is allocated to the section from the 24th OFDM symbol to the 27th OFDM symbol in the first slot SL0 in the cell having the cell ID of CID#2, and the PBCH is allocated to the section from the 20th OFDM symbol to the 21th OFDM symbol and the section from the 26th OFDM symbol to the 27th OFDM symbol in the first slot SL0 in the cell having the cell ID of CID#3.

In this case, since the PBCH allocation region of each cell is reduced to a half as compared to the first exemplary embodiment, the PBCH may be transmitted at transmission power of two times as compared to the first exemplary embodiment.

By the configuration as described above, since an inter-cell PBCH is allocated to different positions in the same slot, the interference of the inter-cell PBCH may be alleviated.

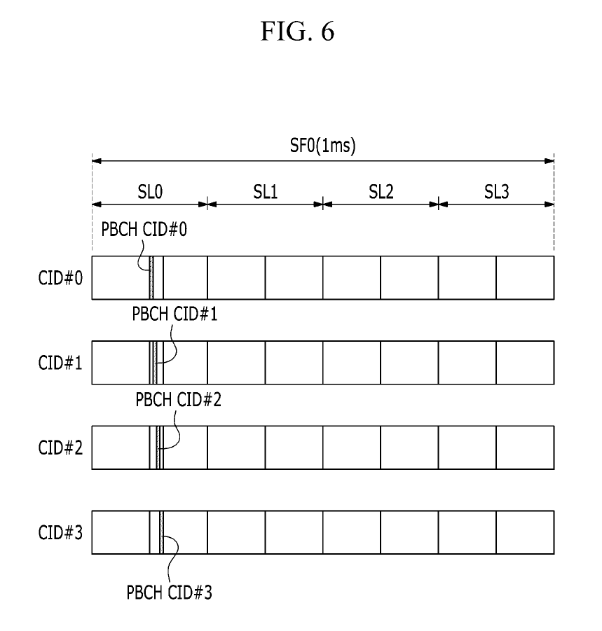

FIG. 6 is a drawing showing a method for allocating PBCH according to a third exemplary embodiment of the present invention.

Referring to FIG. 6, the PBCH of each cell is allocated to positions which are different from PBCHs of the neighboring cells in the same slot using a cell ID and a number of cell IDs, similar to FIG. 5. However, a difference from the allocation method according to the second exemplary embodiment of FIG. 5 is that the PBCH of each cell does not have sections overlapped with the PBCHs of the neighboring cells in the same slot.

For example, in the case in which cells in the MHN system are classified by the four cell IDs (CID#0, CID#1, CID#2, and CID#3), a position to which the PBCH is allocated in the same slot for each cell may be determined according to the remaining value obtained by performing a modular-4 arithmetic function for the values of the cell IDs (CID#0, CID#1, CID#2, and CID#3).

That is, in the cell of (Cell ID mod 4)=0, the PBCH may be allocated to a section from a 20th OFDM symbol to a 21th OFDM symbol in the first slot SL0, in the cell of (Cell ID mod 4)=1, the PBCH may be allocated to a section from a 22th OFDM symbol to a 23th OFDM symbol in the first slot SL0, in the cell of (Cell ID mod 4)=2, the PBCH may be allocated to a section from a 24th OFDM symbol to a 25th OFDM symbol in the first slot SL0, and in the cell of (Cell ID mod 4)=3, the PBCH may be allocated to a section from a 26th OFDM symbol to a 27th OFDM symbol in the first slot SL0.

FIG. 6 shows a case in which the PBCH is allocated to the section from the 20th OFDM symbol to the 21th OFDM symbol in the first slot SL0 in the cell having the cell ID of CID#0, the PBCH is allocated to the section from the 22th OFDM symbol to the 23th OFDM symbol in the first slot SL0 in the cell having the cell ID of CID#1, the PBCH is allocated to the section from the 24th OFDM symbol to the 25th OFDM symbol in the first slot SL0 in the cell having the cell ID of CID#2, and the PBCH is allocated to the section from the 26th OFDM symbol to the 27th OFDM symbol in the first slot SL0 in the cell having the cell ID of CID#3.

In this case, since the PBCH allocation region of each cell is reduced to a quarter as compared to the first exemplary embodiment, the PBCH may be transmitted at transmission power of four times as compared to the first exemplary embodiment.

By the configuration as described above, since an inter-cell PBCH is allocated to different positions in the same slot, the interference of the inter-neighboring cell PBCH may be alleviated.

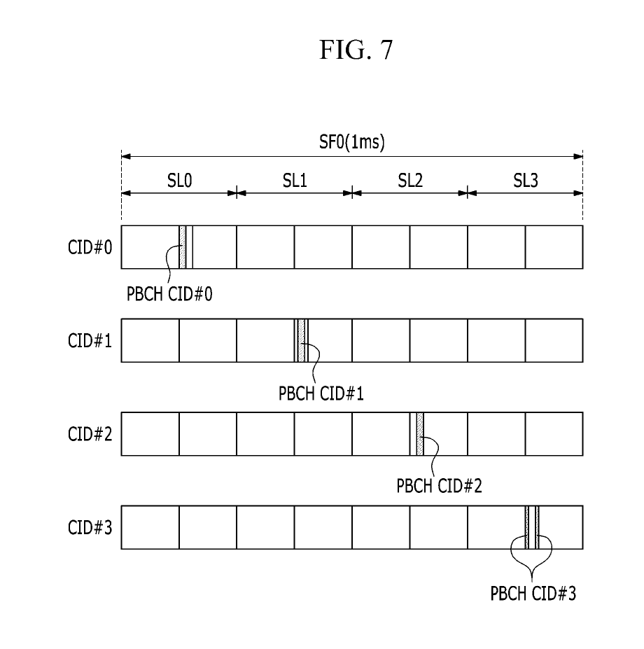

FIG. 7 is a drawing showing a method for allocating PBCH according to a fourth exemplary embodiment of the present invention.

Referring to FIG. 7, the method for allocating the PBCH according to the fourth exemplary embodiment is a method in which the allocation methods described in FIGS. 4 and 5 are mixed, wherein the PBCH of each cell is allocated to slots which are different from the PBCHs of the neighboring cells and different positions in different slots using a cell ID value and a number of cell IDs.

For example, in the case in which cells in the MHN system are classified by the four cell IDs (CID#0, CID#1, CID#2, and CID#3), a position of a slot to which the PBCH is allocated for each cell and a position of an OFDM symbol in the slot may be determined according to the remaining value obtained by performing a modular-4 arithmetic function for the values of the cell IDs (CID#0, CID#1, CID#2, and CID#3).

That is, in the cell of (Cell ID mod 4)=0, the PBCH may be allocated to a section from a 20th OFDM symbol to a 23th OFDM symbol in the first slot SL0, in the cell of (Cell ID mod 4)=1, the PBCH may be allocated to a section from a 22th OFDM symbol to a 25th OFDM symbol in the second slot SL1, in the cell of (Cell ID mod 4)=2, the PBCH may be allocated to a section from a 24th OFDM symbol to a 27th OFDM symbol in the third slot SL2, and in the cell of (Cell ID mod 4)=3, the PBCH may be allocated to a section from a 20th OFDM symbol to a 21th OFDM symbol and a section from a 26th OFDM symbol to a 27th OFDM symbol in the fourth slot SL3.

Also, in this case, since the PBCH allocation region of each cell is reduced to a half as compared to the first exemplary embodiment, the PBCH may be transmitted at transmission power of two times as compared to the first exemplary embodiment.

By the configuration as described above, since an inter-neighboring cell PBCH is allocated to different positions in the same slot, the interference of the inter-neighboring cell PBCH may be alleviated.

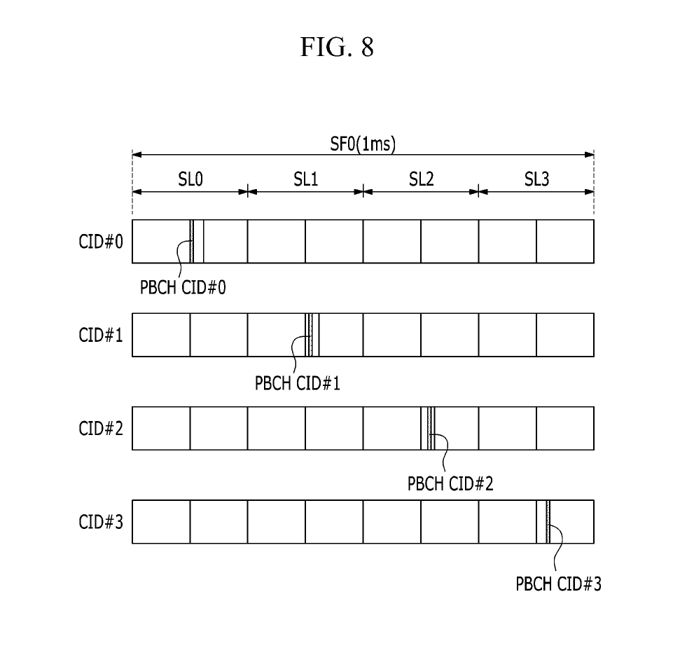

FIG. 8 is a drawing showing a method for allocating PBCH according to a fifth exemplary embodiment of the present invention.

Referring to FIG. 8, the method for allocating the PBCH according to the fifth exemplary embodiment is a method in which the allocation methods described in FIGS. 4 and 6 are mixed, wherein the PBCH of each cell is allocated to slots which are different from the PBCHs of the neighboring cells and different positions in different slots using a cell ID value and a number of cell IDs.

For example, in the case in which cells in the MHN system are classified by the four cell IDs (CID#0, CID#1, CID#2, and CID#3), a position of a slot to which the PBCH is allocated for each cell and a position of an OFDM symbol in the slot may be determined according to the remaining value obtained by performing a modular-4 arithmetic function for the values of the cell IDs (CID#0, CID#1, CID#2, and CID#3).

That is, in the cell of (Cell ID mod 4)=0, the PBCH may be allocated to a section from a 20th OFDM symbol to a 21th OFDM symbol in the first slot SL0, in the cell of (Cell ID mod 4)=1, the PBCH may be allocated to a section from a 22th OFDM symbol to a 23th OFDM symbol in the second slot SL1, in the cell of (Cell ID mod 4)=2, the PBCH may be allocated to a section from a 24th OFDM symbol to a 25th OFDM symbol in the third slot SL2, and in the cell of (Cell ID mod 4)=3, the PBCH may be allocated to a section from a 26th OFDM symbol to a 27th OFDM symbol in the fourth slot SL3.

In this case, since the PBCH allocation region of each cell is reduced to a quarter as compared to the first exemplary embodiment, the PBCH may be transmitted at transmission power of four times as compared to the first exemplary embodiment.

By the configuration as described above, since an inter-neighboring cell PBCH is allocated to different positions in the same slot, the interference of the inter-neighboring cell PBCH may be alleviated.

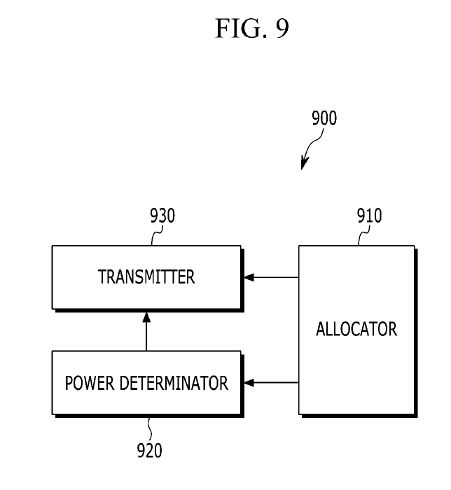

FIG. 9 is a drawing showing an apparatus for allocating a broadcasting channel according to an exemplary embodiment of the present invention.

Referring to FIG. 9, an apparatus 900 for allocating a broadcasting channel includes an allocator 910, a power determinator 920, and a transmitter 930. The apparatus 900 for allocating the broadcasting channel may be implemented in each cell and may also be implemented in a central control apparatus managing each cell.

The allocator 910 determines a position to which the PBCH is to be allocated in the first subframe of the downlink frame and allocates the PBCH using the methods described based on FIGS. 4 to 8. The allocator 910 may allocate the PBCH of the corresponding cell to a position which is different from PBCHs of the neighboring cells, and particularly, may determine an allocation position of the PBCH of the corresponding cell using the cell ID value and the number of cell IDs.

The power determinator 920 checks the number of symbols to which the PBCH is allocated based on the allocation position of the PBCH, and determines transmission power of the PBCH according to the number of symbols to which the PBCH is allocated.

The transmitter 930 transmits the PBCH based on the determined position and transmission power.

At least some of functions of the method and the apparatus for allocating the broadcasting channel according to the exemplary embodiments of the present invention described hereinabove may be implemented in hardware or software combined with the hardware. For example, a processor which is implemented as a central processing unit (CPU), other chipsets, a microprocessor, or the like may perform functions of the allocator 910 and the power determinator 920, and a transmitter may perform a function of the transmitter 930.

According to an embodiment of the present invention, since interference between the inter-cell broadcasting channels may be decreased, transmission performance and detection performance of the broadcasting channel may be improved.

The above-mentioned exemplary embodiments of the present invention are not embodied only by an apparatus and method. Alternatively, the above-mentioned exemplary embodiments may be embodied by a program performing functions which correspond to the configuration of the exemplary embodiments of the present invention, or a recording medium on which the program is recorded. These implementations can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for allocating a broadcasting channel in a cell, the method comprising:
determining a position to which the broadcasting channel is to be allocated, using a number of cell IDs and a cell ID of the cell which is allocated to be different from neighboring cells in a subframe of a downlink frame; and
allocating the broadcasting channel to the determined position.

2. The method of claim 1, wherein the number of cell IDs is determined according to a number of slots in the subframe.

3. The method of claim 1, wherein the determining of the position includes calculating a slot position to which the broadcasting channel is to be allocated, based on a remaining value obtained by performing a modular-N arithmetic function for a value of the cell ID, and N is the number of cell IDs.

4. The method of claim 1, wherein the determining of the position includes calculating a symbol position to which the broadcasting channel is to be allocated in a slot, based on a remaining value obtained by performing a modular-N arithmetic function for a value of the cell ID, and N is the number of cell IDs.

5. The method of claim 1, wherein the determining of the position includes calculating a slot position and a symbol position to which the broadcasting channel is to be allocated, based on a remaining value obtained by performing a modular-N arithmetic function for a value of the cell ID, and N is the number of cell IDs.

6. The method of claim 1, further comprising determining transmission power of the broadcasting channel according to the number of symbols to which the broadcasting channel is allocated.

7. A method for allocating a broadcasting channel in a cell, the method comprising:
allocating the broadcasting channel to a position which is different from neighboring cells using a number of cell IDs and a cell ID of the cell which is allocated to be different from the neighboring cells in a subframe of a downlink frame; and
determining transmission power of the broadcasting channel according to the number of symbols to which the broadcasting channel is allocated.

8. The method of claim 7, wherein the allocating of the broadcasting channel includes determining a slot position based on a remaining value obtained by performing a modular-N arithmetic function for a value of the cell ID, and N is the number of cell IDs.

9. The method of claim 7, wherein
the allocating of the broadcasting channel includes determining a symbol section in the same slot position based on the remaining value obtained by performing a modular-N arithmetic function for a value of the cell ID, and
N is the number of cell IDs.

10. The method of claim 7, wherein the allocating of the broadcasting channel includes determining a slot position and a symbol section based on a remaining value obtained by performing a modular-N arithmetic function for a value of the cell ID, and N is the number of cell IDs.

11. An apparatus for allocating a broadcasting channel in a cell, the apparatus comprising:
an allocator allocating the broadcasting channel to a position which is different from neighboring cells in a subframe of a downlink frame;
a power determinator determining transmission power of the broadcasting channel according to the number of symbols to which the broadcasting channel is allocated; and
a transmitter transmitting the broadcasting channel with the determined transmission power at the allocated position.

12. The apparatus of claim 11, wherein the allocator determines a position to which the broadcasting channel is to be allocated, using a number of cell IDs and a cell ID of the cell which is allocated to be different from the neighboring cells.

13. The apparatus of claim 12, wherein the allocator determines at least one of a slot position and a symbol section in the same slot based on a remaining value obtained by performing a modular-N arithmetic function for a value of the cell ID, and
N is the number of cell IDs.

14. The apparatus of claim 12, wherein the number of cell IDs is the number of slots in the subframe.

15. The apparatus of claim 11, wherein the allocator allocates the broadcasting channel to a slot position which is different from the neighboring cell in the subframe, allocates the broadcasting channel to a symbol section which is different from the neighboring cells in the same slot, or allocates the broadcasting channel to the slot position which is different from the neighboring cells in the subframe and the symbol section which is different from the neighboring cells in the same slot.
